(19) United States
(12) Patent Application Publication
(10) Pub. No.: US 2025/0139494 A1
(43) Pub. Date: May 1, 2025

(54) SYSTEM AND METHOD TO DERIVE AN APPLICATION REQUIREMENT-GUIDED ADAPTIVE LOSS FUNCTION FOR DATA-DRIVEN NEURAL FORECASTER TRAINING

(71) Applicant: International Business Machines Corporation, Armonk, NY (US)

(72) Inventors: Sumanta Mukherjee, Bangalore (IN); Arindam Jati, Bangaluru (IN); Vijay Ekambaram, Chennai (IN); Brian Leo Quanz, Yorktown Heights, NY (US)

(21) Appl. No.: 18/386,019

(22) Filed: Nov. 1, 2023

(51) Int. Cl. G06N 20/00

(52) U.S. Cl. CPC G06N 20/00

(57) ABSTRACT

A computer-implemented method for forecasting a future value of one or more elements of a time-series of data includes obtaining a time-series of data, obtaining a library having a plurality of selected loss functions, obtaining at least one Business Specification Rule (BSR), each BSR including a Context, a Metric and a Priority, for each selected loss function, generating input-associated perturbated outputs based on the BSRs and the time-series of data by training a deep learning artificial intelligence (DLAI) model to learn a set of learned weights to be given to each of the selected loss functions, deriving a custom composite loss function based on the sets of learned weights for the plurality of selected loss functions in the LFL, and using the custom composite loss function to train a final DLAI model on the time-series of data. The final DLAI model may then be used to forecast future outcomes.

### TECHNICAL FIELD

The present disclosure relates generally to methods, storage media containing program instructions and systems all for deriving an application requirement-guided adaptive loss function for data-driven neural forecaster training useable with data driven deep artificial Intelligence (AI) models. Deep learning models are parametric models with a large number of parameters. They are capable of learning from a large volume of data.

### BACKGROUND OF THE INVENTION

The present disclosure is directed to the time series forecasting of future events or data using time-stamped data from the past and a forecasting algorithm to predict future data values. Time series forecasting deals with time-stamped data, that is, data comprising a set of records, each record of which includes a data element reflecting an associated date and/or time that the record relates to. A forecasting algorithm takes as an input a plurality of recent past observed data records and predicts the value of one or more elements of corresponding data records at a future point in time.

Forecasting is used throughout the economy to, for example, assist business owners in determining likely sales volumes so that they can arrange for proper staffing and inventory in advance; assist farmers in determining amounts of seeds to plant and likely weather patterns that will affect growth; in weather forecasting; and many similar sorts of pre-event forecasting of not entirely random events that will, if effective, provide the forecaster with a better outcome than without the forecasting.

Classical forecasting algorithms are parametric and structure driven, i.e., each forecasting algorithm focuses on estimating parameters that best describe a specific structural property of the time series of data. Such models' representation capabilities are restricted, therefore. For each time series of data, a dedicated model must be learned. Due to lack of generalization, usage of such models on high data variety and volume context are restrictive.

Deep learning AI models are composed of a large number of free parameters. These parameters are adjusted in a data driven fashion in a model training step. Such models are trained on a large volume of data (actual and/or simulated) and the parameters are adjusted to minimize a particular loss function.

The loss function typically describes the accuracy of the AI model prediction, given a true value. Different loss functions result in different AI model derivation on the same training data. There are a number of well-known loss functions (sometimes referred to error metrics). These include, for example, RMSE (Root Mean Squared Error), MSE (Mean Squared Error), MAE (Mean Absolute Error), Huber Loss, MAPE (Mean Absolute Percentage Error), SMAPE (Symmetric Mean Absolute Percentage Error), Pinball Loss (also known as “Quantile Loss”), OWA (Ordered Weighted Averaging), Correlation Loss, Anchor First Loss, and many others. Some loss functions are better at forecasting certain types of data than others and they all generally will give somewhat different results for a given time-series of data.

The applications for such forecasting are various business use cases. The forecast quality assessment is often contextual and cannot optimally be captured by a single loss function.

### SUMMARY OF THE INVENTION

A computer-implemented method for forecasting a future value of one or more elements of a time-series of data includes obtaining a time-series of data, obtaining a library having a plurality of selected loss functions (Loss Function Library or LFL), obtaining at least one Business Specification Rule (BSR), each BSR including a Context, a Metric and a Priority, for each selected loss function, generating input-associated perturbated outputs based on the BSRs and the time-series of data by training a deep learning artificial intelligence (DLAI) model to learn a set of learned weights to be given to each of the selected loss functions, deriving a custom composite loss function based on the sets of learned weights for the plurality of selected loss functions in the LFL, and using the custom composite loss function to train a final DLAI model on the time-series of data. The final DLAI model may then be used to forecast future outcomes.

Additional aspects and/or embodiments of the invention will be provided, without limitation, in the Detailed Description of the Invention set forth below.

The foregoing summary may contain simplifications, generalizations and omissions of detail. Those persons of ordinary skill in the art will appreciate that the summary is illustrative only and is not intended to be in any way limiting.

### BRIEF DESCRIPTION OF THE FIGURES

The accompanying drawings, which are incorporated into and constitute a part of this specification, illustrate one or more exemplary embodiments and, together with the Detailed Description of the Invention, serve to explain the principles and implementations of the present invention. In the drawings:

FIG. 1 is a high-level block diagram of a computing environment suitable for use with the embodiments.

FIG. 2 is a process flow diagram illustrating the operation of an embodiment.

FIG. 3 is a graph of data illustrating the rule evaluation process used in accordance with an embodiment.

FIG. 4 is a system diagram illustrating the training to score process used in accordance with an embodiment.

FIG. 5 is a system diagram illustrating the integration to deep learning training in accordance with an embodiment.

### DETAILED DESCRIPTION OF THE INVENTION

Exemplary embodiments are described herein in the context of the time series forecasting of future events or data using time-stamped data from the past and a forecasting algorithm for forecasting a future value of one or more elements of a time-series of data. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

References herein to “one embodiment” or “an embodiment” or “one implementation” or “an implementation” means that a particular feature, structure, part, function or characteristic described in connection with an exemplary embodiment can be included in at least one exemplary embodiment. The appearances of phrases such as “in one embodiment” or “in one implementation” in different places within this specification are not necessarily all referring to the same embodiment or implementation, nor are separate and alternative embodiments necessarily mutually exclusive of other embodiments.

In accordance with this disclosure, the components, process steps, and/or data structures described herein may be implemented using various types of operating systems, computing platforms, computer programs, cloud computing services, and/or general-purpose machines. In addition, those of ordinary skill in the art will recognize that devices of a less general-purpose nature, such as hardwired devices, field programmable gate arrays (FPGAs), application specific integrated circuits (ASICs), or the like, may also be used without departing from the scope and spirit of the inventive concepts disclosed herein.

In accordance with the claims associated with this disclosure, the following terms have the following meanings.
AI Artificial Intelligence
BSR Business Specification Rule
CPP Computer Program Product
DLAI Deep Learning Artificial Intelligence
EUD End User Device
IoT Internet of Things
LFL Loss Function Library
MAPE Loss Mean Absolute Percentage Error Loss Function
MSE Loss Mean Squared Error Loss Function
OWA Loss Ordered Weighted Averaging Loss Function
ROM Read Only Memory
RSME Loss Root Mean Squared Error Loss Function
SD Secure Digital
SDH Software Defined Networking
SMAPE Loss Symmetric Mean Absolute Percentage Error Loss Function
UI User Interface
USB Universal Serial Bus
VCE Virtual Computing Environment
WAN Wide Area Network

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

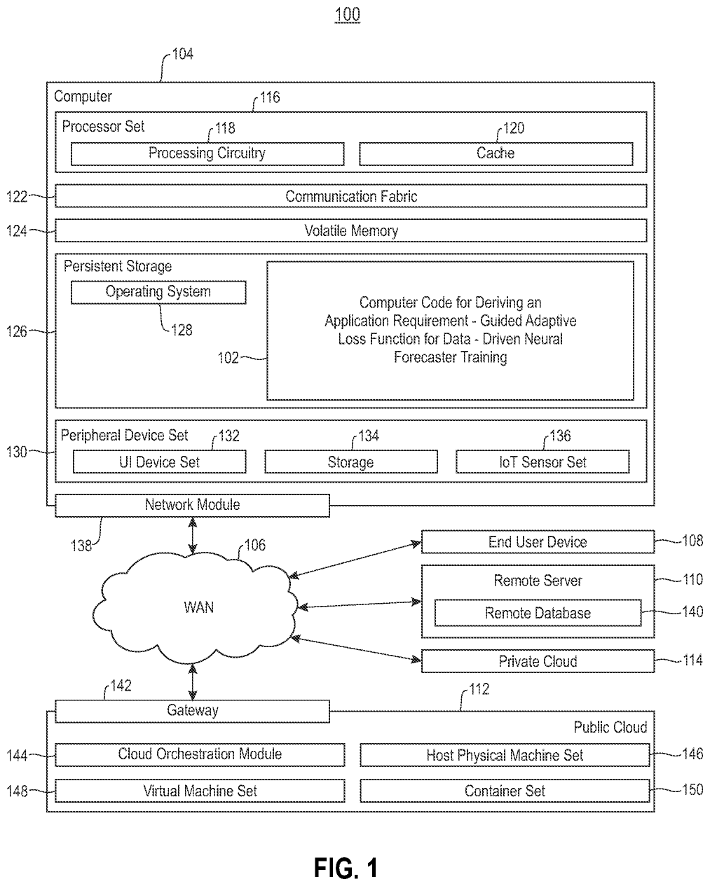

Turning now to the figures, wherein like numbers denote like parts or elements throughout the several views, FIG. 1 depicts a high-level block diagram of a computing environment suitable for use with the embodiments. In FIG. 1 computing environment 100 contains an example of an environment for the execution of at least some of the computer code involved in performing the inventive methods, such as deriving an application requirement-guided adaptive loss function for data-driven neural forecaster training 102. In addition to block 102, computing environment 100 includes, for example, computer 104, wide area network (WAN) 106, end user device (EUD) 108, remote server 110, public cloud 112, and private cloud 114. In this embodiment, computer 104 includes processor set 116 (including processing circuitry 118 and cache 120), communication fabric 122, volatile memory 124, persistent storage 126 (including operating system 128 and block 102 as identified above), peripheral device set 130 (including user interface (UI) device set 132, storage 134, and Internet of Things (IoT) sensor set 136), and network module 138. Remote server 110 includes remote database 140. Public cloud 112 includes gateway 142, cloud orchestration module 144, host physical machine set 146, virtual machine set 148, and container set 150.

Computer 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 140. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 104, to keep the presentation as simple as possible. Computer 104 may be located in a cloud, even though it is not shown in a cloud in FIG. 1. On the other hand, computer 104 is not required to be in a cloud except to any extent as may be affirmatively indicated.

Processor set 116 includes one, or more, computer processors of any type now known or to be developed in the future. Processing circuitry 118 may be distributed over multiple packages, for example, multiple, coordinated integrated circuit chips. Processing circuitry 118 may implement multiple processor threads and/or multiple processor cores. Cache 120 is memory that is located in the processor chip package(s) and is typically used for data or code that should be available for rapid access by the threads or cores running on processor set 116. Cache memories are typically organized into multiple levels depending upon relative proximity to the processing circuitry. Alternatively, some, or all, of the cache for the processor set may be located “off chip.” In some computing environments, processor set 116 may be designed for working with qubits and performing quantum computing.

Computer readable program instructions are typically loaded onto computer 104 to cause a series of operational steps to be performed by processor set 116 of computer 104 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 120 and the other storage media discussed below. The program instructions, and associated data, are accessed by processor set 116 to control and direct performance of the inventive methods. In computing environment 100, at least some of the instructions for performing the inventive methods may be stored in block 102 in persistent storage 126.

Communication fabric 122 is the signal conduction path that allows the various components of computer 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 124 is any type of volatile memory now known or to be developed in the future. Examples include dynamic type random access memory (RAM) or static type RAM. Typically, volatile memory 124 is characterized by random access, but this is not required unless affirmatively indicated. In computer 104, the volatile memory 124 is located in a single package and is internal to computer 104, but, alternatively or additionally, the volatile memory may be distributed over multiple packages and/or located externally with respect to computer 104.

Persistent storage 126 is any form of non-volatile storage for computers that is now known or to be developed in the future. The non-volatility of this storage means that the stored data is maintained regardless of whether power is being supplied to computer 104 and/or directly to persistent storage 126. Persistent storage 126 may be a read only memory (ROM), but typically at least a portion of the persistent storage allows writing of data, deletion of data and re-writing of data. Some familiar forms of persistent storage include magnetic disks and solid-state storage devices. Operating system 128 may take several forms, such as various known proprietary operating systems or open-source Portable Operating System Interface-type operating systems that employ a kernel. The code included in block 102 typically includes at least some of the computer code involved in performing the inventive methods.

Peripheral device set 130 includes the set of peripheral devices of computer 104. Data communication connections between the peripheral devices and the other components of computer 104 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 132 may include components such as a display screen, speaker, microphone, wearable devices (such as goggles and smart watches), keyboard, mouse, printer, touchpad, game controllers, and haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 104 is required to have a large amount of storage (for example, where computer 104 locally stores and manages a large database) then this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 138 is the collection of computer software, hardware, and firmware that allows computer 101 to communicate with other computers through WAN 106. Network module 138 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 138 are performed on the same physical hardware device. In other embodiments (for example, embodiments that utilize software-defined networking (SDN)), the control functions and the forwarding functions of network module 138 are performed on physically separate devices, such that the control functions manage several different network hardware devices. Computer readable program instructions for performing the inventive methods can typically be downloaded to computer 104 from an external computer or external storage device through a network adapter card or network interface included in network module 138.

WAN 106 is any wide area network (for example, the internet) capable of communicating computer data over non-local distances by any technology for communicating computer data, now known or to be developed in the future. In some embodiments, the WAN 106 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 108 is any computer system that is used and controlled by an end user (for example, a customer of an enterprise that operates computer 104), and may take any of the forms discussed above in connection with computer 104. EUD 108 typically receives helpful and useful data from the operations of computer 104. For example, in a hypothetical case where computer 104 is designed to provide a recommendation to an end user, this recommendation would typically be communicated from network module 138 of computer 104 through WAN 106 to EUD 108. In this way, EUD 108 can display, or otherwise present, the recommendation to an end user. In some embodiments, EUD 108 may be a client device, such as thin client, heavy client, mainframe computer, desktop computer and so on.

Remote server 110 is any computer system that serves at least some data and/or functionality to computer 104. Remote server 110 may be controlled and used by the same entity that operates computer 104. Remote server 110 represents the machine(s) that collect and store helpful and useful data for use by other computers, such as computer 104. For example, in a hypothetical case where computer 104 is designed and programmed to provide a recommendation based on historical data, then this historical data may be provided to computer 104 from remote database 140 of remote server 110.

Public cloud 112 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 112 is performed by the computer hardware and/or software of cloud orchestration module 144. The computing resources provided by public cloud 112 are typically implemented by virtual computing environments that run on various computers making up the computers of host physical machine set 146, which is the universe of physical computers in and/or available to public cloud 112. The virtual computing environments (VCEs) typically take the form of virtual machines from virtual machine set 148 and/or containers from container set 150. It is understood that these VCEs may be stored as images and may be transferred among and between the various physical machine hosts, either as images or after instantiation of the VCE. Cloud orchestration module 144 manages the transfer and storage of images, deploys new instantiations of VCEs and manages active instantiations of VCE deployments. Gateway 142 is the collection of computer software, hardware, and firmware that allows public cloud 112 to communicate through WAN 106.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 114 is similar to public cloud 112, except that the computing resources are only available for use by a single enterprise. While private cloud 114 is depicted as being in communication with WAN 106, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 112 and private cloud 114 are both part of a larger hybrid cloud.

In accordance with the embodiments, data driven deep AI models are used. These models are non-parametric in that they contain a large number of free variables. These models are capable of efficient learning from a large volume of data.

A forecasting model training involves using a fixed loss function. A loss function guides the model to learn specific structural aspects from time series data. There are a large number of known loss functions and there is no practical limit to the number of loss functions which may be designed. Some well-known loss functions include: RMSE (Root Mean Squared Error), MSE (Mean Squared Error), MAE (Mean Absolute Error), Huber Loss, MAPE (Mean Absolute Percentage Error), SMAPE (Symmetric Mean Absolute Percentage Error), Pinball Loss (also known as “Quantile Loss”), OWA (Ordered Weighted Averaging), Correlation Loss Function, Anchor First Loss Function, and many others.

Business needs for the forecasting provided by a forecasting model are often dynamic and context driven, for example, one might desire to predict sales during a particular holiday with a bounded prediction error (also known as a prediction interval, e.g., a 95% prediction interval means that the forecast will lie with a 95% probability within the forecasted region and with a 5% probability outside of it); one might like to forecast higher quantiles for low volume sales days; one might like to make an accurate estimation of successive high-volume sales. Other contexts also require forecasting in order to improve readiness, throughput, responses to events and efficiency.

Dynamic business needs suggest that certain loss functions may be appropriate in one situation and less appropriate in others. Indeed, one given loss function may not be perfect in all situations or even in a single situation.

Fully training a DLAI forecasting model on a particular loss function with a full time-series data set can take a considerable amount of time depending upon the size of the data set and the available computing resources. As a result, it will generally be impractical to train every loss function in the LFL on the full data set and even if that were done, then some way of comparing the predictive results of each loss function would be required and it would still not provide a better-trained DLAI.

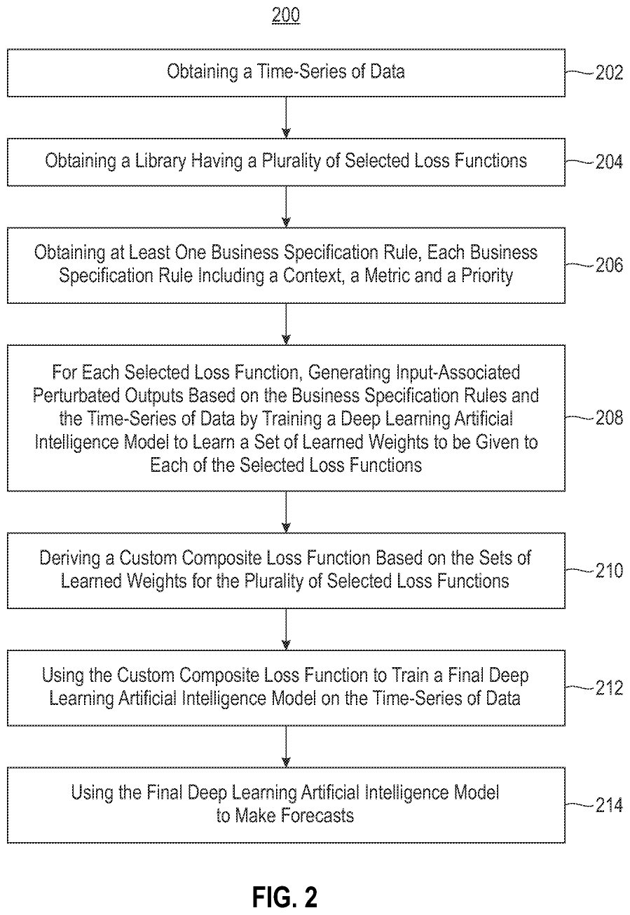

FIG. 2 is a process flow diagram illustrating the operation of an embodiment. In accordance with the process 200 illustrated in FIG. 2, in a first block 202, the process obtains a time-series of data. This is a large volume of training data (data set) which should span a period of time and circumstances sufficient to make predictions about future outcomes. Those of ordinary skill in the art will realize what the requirements are for a data set adequate for a particular situation. The data set may comprise real data captured from actual events, and/or it may be simulated or partially simulated.

In a second block 204 a loss function library of LFL is obtained having a plurality of selected loss functions. The LFL may contain all available loss functions where some, but not all are selected for use in a particular model or just those selected may be present in the LFL. In accordance with the embodiments more than one of the selected loss functions (i.e., 2 or more) will be used to create a “composite loss function” or “adaptive loss function” which is, in effect, a combination of the plurality of loss functions utilized. In this manner, a loss function will be employed to train the forecasting model that is not a standard loss function but is one specifically created to provide good results with a given data set and is, in effect, a composite of more than one standard loss function from the LFL.

In a third block 206, at least one business specification rule (BSR) is obtained (or in some manner specified), each business specification rule including a Context, a Metric and a Priority. The BSRs define, in essence, what is to be forecast. In accordance with an embodiment, the BSR “Context” means a range of time within the time-series data set. The BSR “Metric” is a quantifiable error measure between the true and predicted time series. This is generally determined by the business requirement. For example, if predictions at the peak values are of more importance, a mean squared error metric can be used. The BSR Priority is generally a scalar weight. In a situation where multiple business rules are defined in the same context (i.e., over the same time range in the data set) the priority determines which rule satisfaction is more important, i.e., which rule takes precedence.

In a fourth block 208, for each selected loss function in the LFL (note that the LFL may contain more loss functions than are “selected” for a particular task), input-associated perturbated outputs are generated based on the BSRs and the time-series of data by training a deep learning artificial intelligence model to learn a set of learned weights to be given to each of the selected loss functions. This is done as follows. Each selected loss function in the LFL is used with the data set and the BSRs and conventional data perturbation techniques such as adversarial perturbations, similar to those used in images or speech signals to train each loss function on a neural network, i.e., to determine its affine weights.

In a fifth block 210, a custom composite loss function is derived based on the sets of learned weights for the plurality of selected loss functions. In an embodiment the composite loss function is aligned and correlated with the BSRs to train a neural forecaster to make forecasts. In deriving the single composite loss function, L_{comp} (below), the affine losses and weights from the plurality of selected loss functions from the LFL are aggregated and the aggregation is used to formulate the single composite (final) loss function:

$${L}_{comp} = {α}_{1} {L}_{1} + {α}_{2} {L}_{2} + {α}_{3} {L}_{3}$$

which is the weighted sum of all losses by each loss function by the predicted quotient.

In a sixth block 212, the single custom composite loss function is then used to train a final deep learning artificial intelligence model on the time-series of data in a conventional manner.

In a seventh block 214, the final deep learning artificial intelligence model is used to make forecasts in a conventional manner.

### Rule Specification

A major challenge is the specification of the BSRs used in the embodiments. In the embodiments the BSR is set forth in a declarative manner using a template format. The template includes two distinct components: (1) temporal context specification; and (2) relative weights. The temporal context specification includes three components: (a) a Reference Specification; (b) a Target Specification; and (c) a Relation. The Context Specification is directive guided. It supports predefined directives such as, for example: moving average, moving maximum, moving minimum, high peak, low peak, moving deviation, and the like. Each directive further supports related arguments for complete specification of the directive computation. A Reference Specification is a directive-guided aggregation scheme on the time series values. When the reference specification is applied on the time series, a new transformed/aggregated series is obtained. For example, “moving average” with span=7 produces an aggregated smooth time series. A Target Specification is also a transformation like the devices reference specification. The target specification is applied on the time series to obtain a new transformed series. For example, target specification of “point-value” does a unity transformation, and obtains the same time series. When the target-transformed series is subtracted from the reference-transformed series a new series is obtained. This new series can be compared with the “relation” (such as “greater than”) to obtain a binary series. Relation suggests context selection criteria, which is a comparison between reference specification and target specification. On relation specification, the context is marked “active” or “nonactive,” in terms of a binary vector.

For example, if the BSR is “Value over weekly average, with weight 8”, one may specify it as follows:

```
{
“context”: {
  “reference”: {
    “directive”: “moving average”
    “span”: 7
  },
  “target”: {
    “directive”: “point-value”
  },
  “relation”: “greater”
},
“weight”: 8.0
}
```

### Rule Evaluation Process.

Given an input time series sequence of data: y₁, y₂, y₃, . . . y_{T} each business logic produces a sequence tuple containing a binary (0, 1) flag, and an associated scalar weight at each time point: (δ₁(1), w₁), (δ₁(2), w₁), . . . (δ₁(T), w₁).

Given a set of business rules a weighted context matrix is produced: Σⱼδⱼ(1)wⱼ, τⱼδⱼ(2) wⱼ, . . . Σⱼδⱼ(T)wⱼ. These weighted context matrices are uniquely defined for each time segment, given the fixed set of BSRs. The sequence of weighted context matrices defines the temporal sensitivity of the final metric, i.e., error at highly weighted time points should create a larger variation in the loss function compared to time points where the weights are less.

The adversarial perturbation is constructed in the following manner: ŷₜ=yₜ+ϵₜ. Then the error (ϵₜ) is constructed for each time-series of data using the sensitivity context.

Since the weight sequence defines the temporal sensitivity of the final metric, the highly weighted time points have more sensitivity, and forecast error from a forecasting model should be highly penalized at those points. Hence, the optimal loss function that is sought should produce higher error at those points. This is the “sensitivity context”, which is used by the perturbation engine to generate adversarial perturbations.

### Example

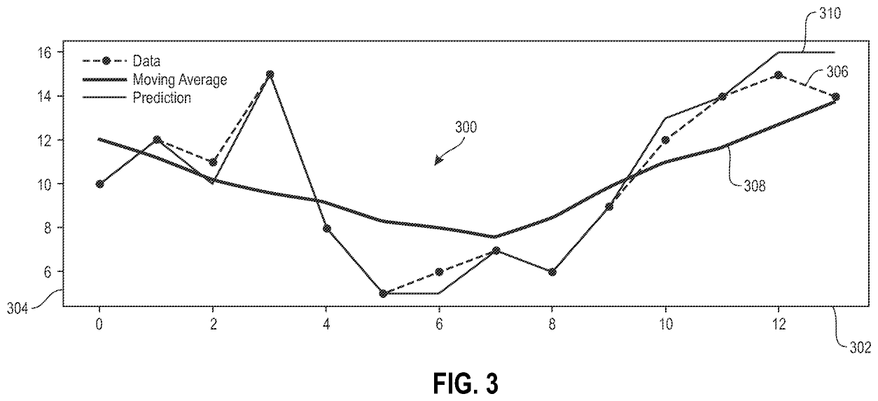

FIG. 3 is a graph 300 of data illustrating the rule evaluation process used in accordance with an embodiment. The horizontal or X-axis 302 represents time increasing toward the right and the vertical or Y-axis 304 represents a scalar value of the data increasing in the upward direction. The actual data is shown in set 306, a moving average of the data is shown in set 308, and the predicted value is shown in set 310.

Given an input time series sequence: Xᵢₙ=10, 12, 11, 15, 8, 5, 6, 7, 6, 9, 12, 14, 15, 14, each BSR produces a sequence tuple having a binary (0, 1) flag (Bᵢ), and an associated scalar weight (wᵢ) at each time point. By this example, Value Over Running 7 Days Window Mean is (w₁: 1) and B₁=0,1,1,1,0,0,0,0,0,0,1,1,1,1; Deviation Over 7 Days Window Mean Is Over Median is (w₂: 4) and B₂=1,0,0,1,0,1,1,0,1,0,0,1,1,0.

Now, using the loss functions RMSE and SMAPE, and given a set of BSRs, a weighted context matrix is produced: W_{T}=B₁w₁+B₂w₂=4,1,1,5,0,4,4,0,4,0,1,5,5,1 and then perturbed to emulate a predictor scenario: X₁=10,12,10,15,8,5,5,7,6,9,13,14,16,16. A predictor/forecaster generates a predicted time series. The perturber emulates similar scenario by generating adversarial perturbation of a time series.

This allows a specific ordering context for a specified sequence of deviation: S_{deviation}=ε((X₁−Xᵢₙ)W(X₁−Xᵢₙ)) then Affine modelling is used to derive an empirical score: S_{empirical}=α₁(Xᵢₙ)*RMSE (Xᵢₙ, X₁)+α₂(Xᵢₙ)*SMAPE (Xᵢₙ, X₁). Then training ensures that deviation scores align with empirical scores:

S_{deviation}(i)<S_{deviation}(j)=>S_{empirical}(i)<S_{empiricial}(j)

### Input Examples of a BSR.

The LFL includes the following selected loss functions: (1) RMSE (θ₁); (2) MAPE (θ₂); (3) OWA (θ₃); and (4) Quantile Loss (θ₄). The BSRs are: (1) Seasonal sales peak must be correctly predicted. (The use of the RMSE loss function would achieve this); (2) On low sales time average sales must be correctly predicted. ([ε(y, ŷ)=∥ŷ−E(y)|]); (3) The forecast should not miss any peak sales. (The use of the MAPE loss function would achieve this); and (4) The forecast should never predict below the 25% quantile (the use of the Pinball Loss/Quantile Loss Function would achieve this).

### Training of the Loss Function.

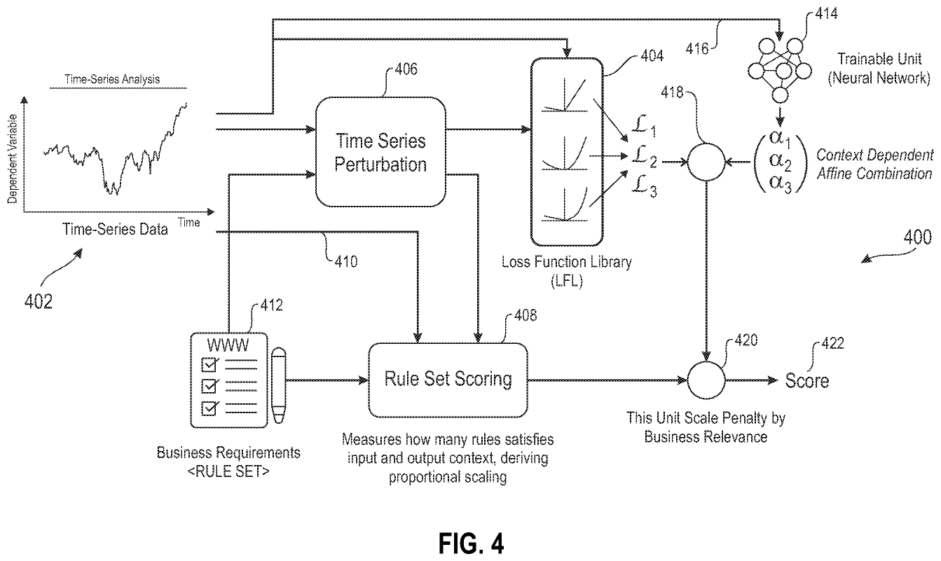

FIG. 4 is a system diagram illustrating the training to score process used in accordance with an embodiment.

The loss function training is model independent, i.e., each selected loss function is trained on the time-series data set independently to achieve a minimum loss for that loss function subject to the BSRs. The data set used in training the loss functions may be a representative actual time-series of data and/or it may be generated (simulated) using some conventional form of data generator. The input/output pair are generated using conventional time-series perturbation methods. The perturbations are restricted by a Max Perturbation Bound. A Max Perturbation Bound is the highest perturbation that is allowed. For example, 20% perturbation of a (0-1) normalized series means that the maximum allowed value after perturbations will be 1.20. Similarly, where a Minimum Perturbation Bound is used it is the minimum perturbation that is allowed and a 20% perturbation under similar circumstances would yield a minimum allowed value of 0.80. The perturbation machineries are parametric in nature.

For each input and perturbed output, a target score, such as a standard deviation, is computed directly by evaluating the BSRs in effect. This evaluation is deterministic, i.e., a target score is deterministic because it does not change given a time series, a perturbed series, and a BSR.

For each input it is assumed that the business context can be evaluated deterministically given the input data. The context provides a Boolean decision, i.e., whether to evaluate/compute at that time point that particular associated error (as set forth in the BSR) or not.

If at any given time point in the time series data multiple rules are fired, i.e., met, the rules having the highest priority are selected for use. A default rule is always true. A BSR can have multiple rules. If none are provided, it can have a default rule which is True at all time points. For example, a default rule can be mean squared error (MSE) at all time points.

The data perturbation schemes are adversarial in nature, that is, they try to sample data preferentially to challenge the model. Both input and predicted sequences are sent to the neural network model. The neural network encodes the input sequence into an embedding using sequence modeling. The embeddings are future used for model prediction, i.e., affine combination generation. An embedding is a fixed dimensional vector that is extracted from a hidden layer of a neural network. It generally denotes a representation of the input. For example, a variable length time series can be represented by a 128-dimensional embedding extracted from the 2nd layer of a recurrent neural net. Thus, the embeddings can be subsequently used for generating the weights that are utilized to obtain the combined loss.

Turning now in more detail to FIG. 4, the System Diagram 400 describes the operations that follow. The time-series of data is provided at 402. Data 402 is provided to each of the selected loss functions [symbol] ₁, [symbol] ₁, and [symbol] ₁ in loss function library (LFL) 404. Data 402 is also time-series perturbated at Time Series Perturbator (TSB) 406 and provided to LFL and to a rule set scoring function 408 which also receives the time-series data 402 directly over path 410. BSRs 412 are provided to the TSB 406 from an input block 412 from where they are input or obtained from pre-stored data in some manner. A trainable unit such as a neural network 414 receives the time-series data 402 over path 416. At 418, the affine combination of losses, L=α₁L₁+α₂L₂+α₃L₃, is implemented. At 420, (S_empirical−S_deviation)\hat{ }2 is implemented. At 422, the result of 420 is a loss function score used to train the neural network in FIG. 4.

### System Diagram (Integration to Deep Learning Training).

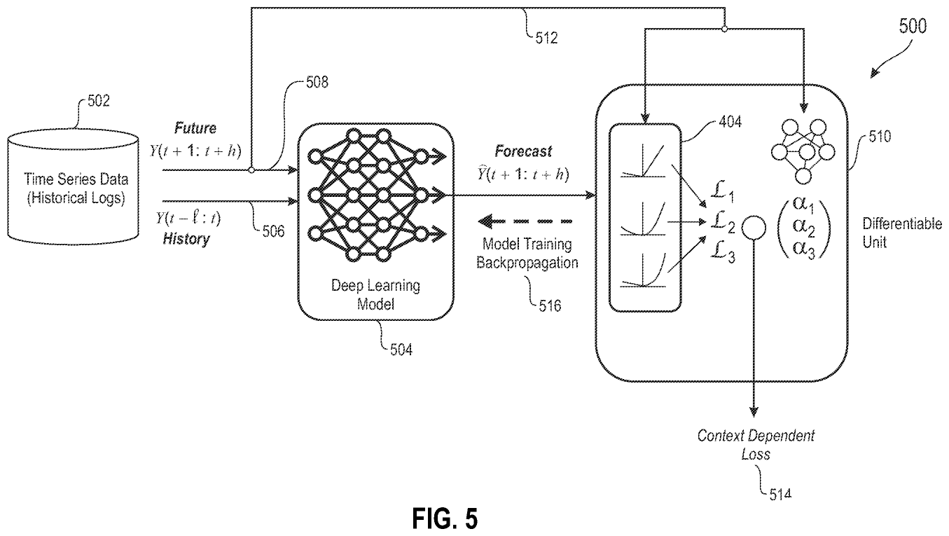

Once the scoring model is optimized, the derived scoring model from FIG. 4 can be directly used as a loss function in model training (FIG. 5). It must be noted, the final scoring function is an additive function, it is smooth, continuous and differentiable. The trained scoring function best satisfies all business constraints, and thereby guides the model to learn the appropriate patterns. The adversarial training of the scoring function ensures that it is not biased. It must be noted the scoring function involves time series embedding. Thus, if trained using a generator model, or on large training data set, this guarantees good performance of the scoring function over the training data.

FIG. 5 is a system diagram 500 illustrating integration to deep learning training. In the system shown in FIG. 5 the trained differentiable single composite loss function is used during the training of the final DLAI model. The trained loss function is already optimized for context dependent BSRs and maintained as is during the final DLAI model training phase.

Time-series data 502 is provided to DLAI model 504 over two paths: 506 for historical data (Y(t− [symbol] :t)) and 508 for future data (Y(t+1:t+h)). DLAI model 504 is a conventional deep learning AI model implemented in a conventional manner as well known to those of ordinary skill in the art. DLAI model 504 provides forecast data Ŷ(t+1:t+h) to a differentiable unit 510 like that explained above in the context of FIG. 4. Differentiable Unit 510 receives the future data Y(t+1:t+h) on path 512 and generates context dependent loss data as an output at 514. It provides model training backpropagation data on path 516 to DLAI model 504 for use in training the final DLAI model 504. The trained differentiable loss function (i.e., the single composite loss function determined earlier) is already optimized for context dependent business requirements (BSRs), and maintained as is during the model training phase. It is used during the training of the entire DLAI model.

Here, the final forecasting model with optimal scoring/loss function is trained. To train a forecaster, training samples in the form of (X, Y) pairs from historical data are used. Here, X denotes a historical context, and Y denotes the actual future. For example, assume there is a dataset of hourly measurement of electricity demand for the last one year. The task is to build a forecaster than can predict the demand for next 24 hours given last one week's data. Hence, create (X,Y) pairs by moving along the 1-year long time series, where X=1 week window, Y=Next 24 hours window. These (X,Y) pairs are fed to the neural net for training. In FIG. 5, 502 stores all the historical data from which a dataloader mines these (X,Y) pairs.

### CONCLUSION

In accordance with the embodiments, the composite loss function connects the BSRs to the model training loss, the model accuracy for a data segment with large anomalous peaks instead of consistent cyclic patterns is improved by access to multiple loss functions in the formulation of the composite loss function.

While exemplary embodiments and applications have been shown and described, it would be apparent to those skilled in the art having the benefit of this disclosure that numerous modifications, variations and adaptations not specifically mentioned above may be made to the various exemplary embodiments described herein without departing from the scope of the invention which is defined by the appended claims.

We claim:

1. A computer-implemented method for forecasting a future value of one or more elements of a time-series of data, the method comprising:
obtaining a time-series of data;
obtaining a loss function library (LFL) having a plurality of selected loss functions;
obtaining at least one Business Specification Rule (BSR), each BSR including a Context, a Metric and a Priority;
generating, for each selected loss function in the LFL, input-associated perturbated outputs based on the BSRs and the time-series of data by training a deep learning artificial intelligence (DLAI) model to learn a set of learned weights to be given to each of the plurality of selected loss functions in the LFL;
deriving a custom composite loss function to train a final DLAI model based on the sets of learned weights for the plurality of loss functions; and
using the custom composite loss function to train a final DLAI model on the time-series of data.

2. The method of claim 1, further comprising using the final DLAI model to make forecasts.

3. The method of claim 2, wherein the time series of data is at least partially simulated.

4. The method of claim 2, wherein the time series of data is actual data.

5. The method of claim 1, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

6. The method of claim 2, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

7. The method of claim 4, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

8. A computer program product for forecasting a future value of one or more elements of a time-series of data, the computer program product comprising:
one or more computer readable storage media, and program instructions collectively stored on the one or more computer readable storage media, the program instructions comprising:
program instructions to obtain a time series of data;
program instructions to obtain a loss function library (LFL) having a plurality of selected loss functions;
program instructions to obtain at least one Business Specification Rule (BSR), each BSR including a Context, a Metric and a Priority;
program instructions to, for each selected loss function in the LFL, generate input-associated perturbated outputs based on the BSRs and the time-series of data by training a deep learning artificial intelligence (DLAI) model to learn a set of learned weights to be given to each of the plurality of selected loss functions in the LFL;
program instructions to derive a custom composite loss function to train a final DLAI model based on the sets of learned weights for the plurality of loss functions; and
program instructions to use the custom composite loss function to train a final DLAI model on the time-series of data.

9. The computer program product of claim 8, wherein the program instructions further comprise program instructions to use the final DLAI model to make forecasts.

10. The computer program product of claim 9, wherein the time series of data comprises data that has been at least partially simulated.

11. The computer program product of claim 9, wherein the time series of data comprises data that is entirely actual data.

12. The computer program product of claim 8, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

13. The computer program product of claim 9, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

14. A computer system comprising:
a processor; and
memory connected to the processor, wherein the memory encodes instructions that when executed by the processor include:
instructions for carrying out a computer-implemented method for forecasting a future value of one or more elements of a time-series of data, the instructions including:
instructions for obtaining a time series of data;
instructions for obtaining a loss function library (LFL) having a plurality of selected loss functions;
instructions for obtaining at least one Business Specification Rule (BSR), each BSR including a Context, a Metric and a Priority;
instructions to, for each selected loss function in the LFL, generate input-associated perturbated outputs based on the BSRs and the time-series of data by training a deep learning artificial intelligence (DLAI) model to learn a set of learned weights to be given to each of the plurality of selected loss functions in the LFL;
instructions for deriving a custom composite loss function to train a final DLAI model based on the sets of learned weights for the plurality of loss functions; and
instructions for using the custom composite loss function to train a final DLAI model on the time-series of data.

15. The computer system of claim 14, wherein the instructions further comprise instructions to make forecasts with the final DLAI model.

16. The computer system of claim 15, wherein the time series of data comprises data that has been at least partially simulated.

17. The computer system of claim 15, wherein the time series of data comprises data that is entirely actual data.

18. The computer system of claim 14, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

19. The computer system of claim 15, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.

20. The computer system of claim 17, wherein the LFL includes at least two loss functions selected from the group consisting of: RMSE Loss, MSE Loss, MAE Loss, Huber Loss, MAPE Loss, SMAPE Loss, Quantile Loss, OWA Loss, Correlation Loss and Anchor First Loss.
